(19) United States
(12) Patent Application Publication
(10) Pub. No.: US 2026/0087031 A1
(43) Pub. Date: Mar. 26, 2026

(54) COMMUNICATION SYSTEM, INFORMATION PROCESSING APPARATUS, AND INFORMATION PROCESSING METHOD

(71) Applicant: TOYOTA JIDOSHA KABUSHIKI KAISHA, Toyota-shi (JP)

(72) Inventor: Iwao NITTA, Nagoya-shi (JP)

(73) Assignee: TOYOTA JIDOSHA KABUSHIKI KAISHA, Toyota-shi (JP)

(21) Appl. No.: 19/326,207

(22) Filed: Sep. 11, 2025

(30) Foreign Application Priority Data
Sep. 20, 2024 (JP) 2024-164387

(51) Int. Cl. G06F 16/26; G06F 16/22; G06Q 20/10

(52) U.S. Cl. CPC G06F 16/26; G06F 16/2282; G06Q 20/10

(57) ABSTRACT

An information processing apparatus includes a storage configured to store one or more pieces of information on a target object for each of its items, and a controller. The controller of the information processing apparatus accepts, from a first user, a request to browse a target item among the plurality of items in the storage. The controller of the information processing apparatus requests the first user to execute a predetermined procedure. The controller of the information processing apparatus permits the first user to browse the target item in response to execution of the predetermined procedure. The predetermined procedure is determined according to a level of importance set for the target item.

### CROSS REFERENCE TO THE RELATED APPLICATION

This application claims the benefit of Japanese Patent Application No. 2024-164387, filed on Sep. 20, 2024, which is hereby incorporated by reference herein in its entirety.

### BACKGROUND

### Technical Field

The present disclosure relates to a communication system, an information processing apparatus, and an information processing method.

### Description of the Related Art

Patent Literature 1 discloses a system configured to collect data measured by equipment installed in a plant and discloses the collected data to a contractor in exchange for compensation.

### CITATION LIST

### Patent Literature

Patent Literature 1: Japanese Patent Application Laid-Open Publication No. 2021-86394

### SUMMARY

The object of the present disclosure is to provide a technique capable of appropriately providing and browsing information on a target object.

One aspect of the present disclosure may be an information processing apparatus. In this case, the information processing apparatus may include, for example: a storage configured to store one or more pieces of information on a target object for each of its items; and
a controller;
wherein the controller may be configured to execute:
   accepting, from a first user, a request to browse a target item, which is one of the plurality of items in the storage;
   requesting a predetermined procedure to the first user; and
   permitting the first user to browse the target item in response to execution of the predetermined procedure; and
wherein the predetermined procedure may be determined according to a level of importance set for the target item.

Another aspect of the present disclosure may be an information processing method. The information processing method in this case may cause, for example, a computer including a storage configured to store one or more pieces of information on a target object for each of its items to execute:
accepting, from a first user, a request to browse a target item, which is one of the plurality of items in the storage;
requesting a predetermined procedure to the first user; and
permitting the first user to browse the target item in response to execution of the predetermined procedure; and
wherein the predetermined procedure may be determined according to a level of importance set for the target item.

The present disclosure can also be considered as a program for causing a computer to execute the above-mentioned information processing method or a computer-readable storage medium in which the program is stored in a non-transitory manner.

Note that the present disclosure can also be considered as a communication system. The communication system in this case may include:
a plurality of terminals; and
a server connected to the plurality of the terminals,
wherein the server may includes:
a storage configured to store a first data table which registers one or more pieces of information on a target object for each of its entries; and
a controller configured to execute a web server that interacts with the plurality of terminals;
wherein the web server may be configured to execute:
   receiving, from a first terminal which is one of the plurality of terminals, a request signal to access a target entry, which is one of the plurality of entries in the first table;
   determining a level of importance set for the target entry among levels of importance respectively set for the plurality of entries;
   determining a consideration corresponding to the level of importance of the target entry;
   transmitting a request signal for settlement of the consideration to the first terminal; and
   transmitting a command signal for displaying information of the target entry on a display device of the first terminal to the first terminal, in response to receiving settlement completion signal from the first terminal.

According to the present disclosure, it is possible to provide a technique capable of appropriately providing and browsing information on a target object.

### BRIEF DESCRIPTION OF THE DRAWINGS

FIG. 1 is a diagram illustrating an overview of a system in an embodiment;

FIG. 2 is a diagram illustrating an example of battery information provided to a management server from terminals and a vehicle server included in the system in the embodiment;

FIG. 3 is a diagram schematically illustrating an example of a hardware configuration of each of the management server, the terminals, and the vehicle server included in the system in the embodiment;

FIG. 4 is a block diagram illustrating an example of a software configuration of the management server in the embodiment;

FIG. 5 is a diagram schematically illustrating an example of a configuration of a battery information table in the embodiment;

FIG. 6 is a diagram schematically illustrating an example of an importance correspondence table in the embodiment;

FIG. 7 is a diagram schematically illustrating an example of a consideration correspondence table in the embodiment;

FIG. 8 is a block diagram illustrating an example of a software configuration of a terminal in the embodiment;

FIG. 9 is a diagram illustrating a first example of a battery information display screen displayed on the terminal in the embodiment;

FIG. 10 is a diagram illustrating an example of a screen displayed on the terminal for prompting a user to select whether or not to agree to pay the consideration in the embodiment.

FIG. 11 is a diagram illustrating a second example of the battery information display screen displayed on the terminal in the embodiment;

FIG. 12 is a block diagram illustrating an example of a software configuration of the vehicle server in the embodiment; and

FIG. 13 is a flowchart illustrating an example of a processing routine to be executed by the management server in the embodiment.

### DESCRIPTION OF THE EMBODIMENTS

From manufacturing to recycling for batteries used in vehicles such as BEVs (Battery Electric Vehicles), HEVs (Hybrid Electric Vehicles), and PHEVS (Plug-in Hybrid Electric Vehicles), there are included various phases such as a battery manufacturing phase, a vehicle manufacturing phase, a new vehicle utilization phase, a used vehicle auction phase, a used vehicle utilization phase, a vehicle dismantling phase, a battery diagnostic phase, a battery auction phase, a recycling phase, etc. Therefore, the construction of platforms for collecting and centrally managing information from users (business operators, etc.) involved in each of these multiple phases is being studied.

The information centrally managed on the platforms as described above includes information on the know-how of business operators and the privacy of vehicle purchasers, and hence, unconditional permission to browse such information may harm the interests of the users who provide the information. On the other hand, if the browsing of the above-mentioned information is restricted, the interests of users who want to browse the information may be impaired. Therefore, it is desirable to have a technology that is effective in achieving a balance between the interests of users who provide information and users who browse the information.

In view of this, an information processing apparatus, which is one aspect of the present disclosure, is configured to store information on a target object for each of its items, and permit browsing of the information for each item on the condition that a predetermined procedure is executed according to the level of importance for each item.

In detail, an information processing apparatus according to the present disclosure includes a storage configured to store one or more pieces of information on a target object for each of its items, and a controller. In one example, the target object may be a battery for driving a vehicle. However, the target object is not limited to a battery for driving a vehicle, but may be any product that is distributed through a plurality of phases from manufacturing to recycling. In addition, the information on the target object may be information provided by a plurality of users involved in a plurality of phases from manufacturing to recycling of the target object.

The controller of the information processing apparatus according to the present disclosure accepts, from a first user, a request to browse a target item, which is one of the plurality of items in the storage. The first user may be a user involved in one of the plurality of phases from manufacturing to recycling of the target object. The acceptance of the request to browse (hereinafter, also referred to as a browsing request) may be executed by transmitting a browsing request signal from a terminal of the first user to the information processing apparatus. Alternatively, the information processing apparatus may accept a browsing request operation from the terminal of the first user through the execution of a web server.

The controller of the information processing apparatus according to the present disclosure requests the first user to execute the predetermined procedure in response to the acceptance of the request to browse the target item from the first user. The predetermined procedure in the present disclosure is determined according to the level of importance of information of the target item. In one example, the predetermined procedure may include provision of a consideration to a second user who is an information provider of the target item. The consideration in this case may be set to be larger as the level of importance of the target item is higher. In one example, the level of importance in the present disclosure may be set to a level that increases as the degree of influence on the business of the second user who is the information provider of the target item increases. Examples of the information with a large degree of influence on the business of the second user include information from which the know-how of the second user can be grasped, such as a battery diagnosis method. In another example, the level of importance may be set to a higher level as the accuracy of the information of the target item is higher. The accuracy of the information may be determined, for example, according to whether the information of the target item is an actual measured value or an estimated value. In such an example, when the information of the target item is an actual measured value, the accuracy of the information may be higher than when the information of the target item is an estimated value. The level of importance as described above is set for each of the plurality of items in the storage. Accordingly, the contents of the predetermined procedure as described above may be different for each of the plurality of items in the storage.

The controller of the information processing apparatus according to the present disclosure permits the first user to browse the target item in response to the execution of the predetermined procedure by the first user. Permitting the first user to browse the target item may include transmitting the information of the target item to the terminal of the first user, or displaying the information of the target item on the terminal of the first user or the like. Also, permitting the first user to browse the target item may further include providing the first user with information that guarantees the reliability of the information of the target item. In one example, the information guaranteeing the reliability of the information of the target item may be a signature of a manufacturer of the target object, a manufacturer of a product on which the target object is mounted, a third-party organization, or the like. Note that the execution of the predetermined procedure by the first user may be determined, in one example, by the fact that the controller of the information processing apparatus of the present disclosure has finished executing the process of charging the first user with the consideration for the second user.

In addition, the storage of the information processing apparatus according to the present disclosure may be configured to further store first information that associates each of the plurality of items with a level of importance. In this case, the controller of the information processing apparatus according to the present disclosure may identify the level of importance of the target item according to the first information.

Also, the storage of the information processing apparatus according to the present disclosure may be configured to further store second information that associates a level of importance with the predetermined procedure. In this case, the controller of the information processing apparatus according to the present disclosure may determine the predetermined procedure corresponding to the level of importance of the target item according to the second information.

According to the information processing apparatus of the present disclosure, browsing of the target item by the first user is permitted on the condition that the first user executes the predetermined procedure corresponding to the level of importance of the target item. Accordingly, it is possible to reduce disadvantages to the user (second user) who is the information provider of the target item. In addition, the first user can browse the information to which the level of importance corresponding to the predetermined procedure is assigned. As a result, it becomes possible to harmonize the interests of the first user and the second user.

Hereinafter, specific embodiments of the present disclosure will be described based on the accompanying drawings. The hardware configuration, module configuration, functional configuration, and the like described in the following embodiments are not intended to limit the technical scope of the disclosure only to them unless otherwise specified.

### EMBODIMENT

In the present embodiment, an example will be described in which an information processing apparatus according to the present disclosure is applied to a system that centrally manages information on batteries in the process from the time they are manufactured until they are recycled. The batteries in the present embodiment are those for driving an electric vehicle such as a BEV, a PHEV, and an HEV, and are each an example of a target object in the present disclosure.

### (Overview of System)

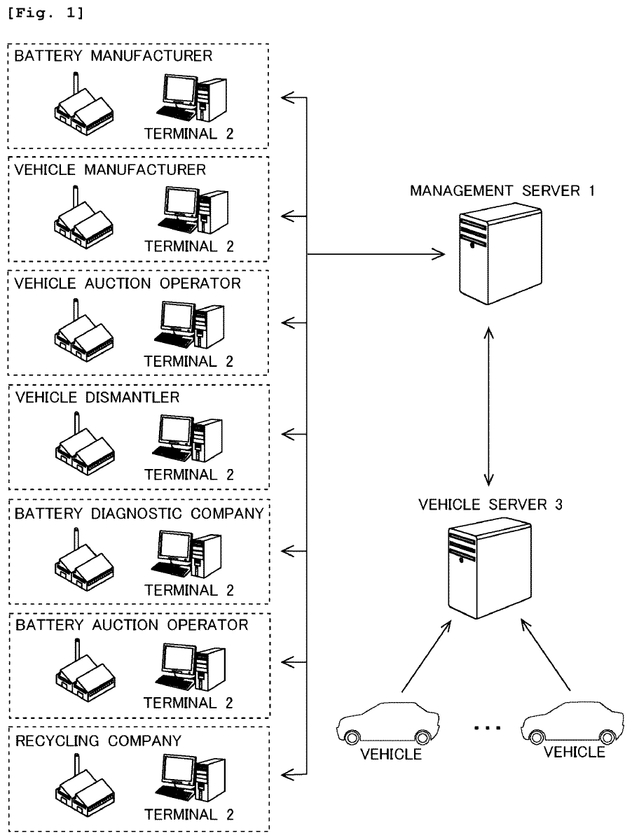

FIG. 1 is a diagram illustrating an overview of a system according to an embodiment. The system in the present embodiment includes a management server 1, one or more terminals 2, and one or more vehicle servers 3. The management server 1 is connected to the terminals 2 and the vehicle server 3 via a network. The network is, for example, a worldwide public communication network such as the Internet or the like, and a WAN (Wide Area Network) or other communication networks may be adopted. Also, the network may include a telephone communication network such as a mobile phone network or the like, and/or a wireless communication network such as Wi-Fi (registered trademark) or the like.

The management server 1 is one or more computers that manage information on batteries in a process from manufacturing to recycling of the batteries (hereinafter also referred to as a “battery life cycle”). The management server 1 in the present embodiment collects information on the batteries (hereinafter, sometimes referred to as “battery information”) from a plurality of users involved in the battery life cycle, and centrally manages the collected battery information. In addition, the management server 1 according to the present embodiment provides the battery information to a user who wants to browse the battery information. Note that in the present embodiment, the management server 1 corresponds to an information processing apparatus according to the present disclosure.

The terminals 2 are terminal devices used by a plurality of users involved in a battery in the battery life cycle. In one example, the battery life cycle includes a battery manufacturing phase (a phase of manufacturing a battery for vehicle driving), a vehicle manufacturing phase (a phase of manufacturing a vehicle on which the battery for vehicle driving is mounted), a new vehicle utilization phase (a phase in which a new vehicle purchaser utilizes the new vehicle), a vehicle auction phase (a phase of selling and buying the vehicle from the new vehicle purchaser to a used vehicle purchaser), a used vehicle utilization phase (a phase in which the used vehicle purchaser utilizes the used vehicle), a vehicle dismantling phase (a phase of dismantling the used (scrapped) vehicle), a battery diagnostic phase (a phase of diagnosing the battery recovered from the scrapped vehicle), a battery auction phase (a phase of selling and buying the diagnosed battery), and a recycling phase (a phase of producing recycled materials from the used battery (waste battery)). The users involved in the battery life cycle in this example include a battery manufacturer, a vehicle manufacturer, a vehicle auction operator, a vehicle dismantler, a battery diagnostic company, a battery auction operator, a recycling company, etc.

The phases included in the battery life cycle are not limited to the above-mentioned example, but a phase of mining materials of the battery, a phase of manufacturing precursors and active materials of the battery, a phase of recovering the battery from the disassembled vehicle, or the like may be added. In this case, the users involved in the battery life cycle may include, in addition to the above-mentioned users, mining companies, precursor/active material manufacturers, battery recovery companies, and the like. In addition, when a vehicle purchased as a new vehicle is scrapped without being sold as a used vehicle, the vehicle auction phase and the used vehicle utilization phase may be omitted.

Note that in the following description, in the battery life cycle, the battery manufacturing phase side is referred to as “previous”, and the recycling phase side is referred to as “subsequent”. Accordingly, the phase immediately preceding each phase is referred to as a previous phase, and the phase immediately following each phase (next phase) is referred to as a subsequent phase.

A terminal 2 of a user involved in each phase provides battery information in each phase to the management server 1. In addition, the user involved in each phase can browse battery information for at least the phase in which the user himself or herself is involved and the previous phase by logging into the management server 1 through his or her terminal 2. However, in the present embodiment, a browsing restriction is set on at least a part of the battery information in the previous phase.

Information for which the browsing restriction has been set can be browsed by a user who wants to browse the information paying a consideration or fee. The consideration paid is granted to the user who provided the information in question (the user involved in the previous phase).

The vehicle server 3 collects, from a vehicle under its management, various types of information on the battery mounted on the vehicle. The information collected by the vehicle server 3 is information that becomes necessary when generating battery information corresponding to the new vehicle utilization phase and the used vehicle utilization phase. In one example, the information collected from the vehicle may be information necessary for estimating the state of health of the battery (e.g., SoH (State of Health), SoC (State of Charge), SoCE (State of Certified Energy), SoS (State of Safety), etc.). The vehicle server 3 generates battery information corresponding to the new vehicle utilization phase and the used vehicle utilization phase according to information collected from a plurality of vehicles, and provides the battery information thus generated to the management server 1. The information collected by the vehicle server 3 and the battery information generated by the vehicle server 3 may, in one example, be attributed to a vehicle manufacturer or a vehicle dealer. In this case, the user involved in the new vehicle utilization phase and the used vehicle utilization phase may be a vehicle manufacturer or a vehicle dealer.

### [Battery Information]

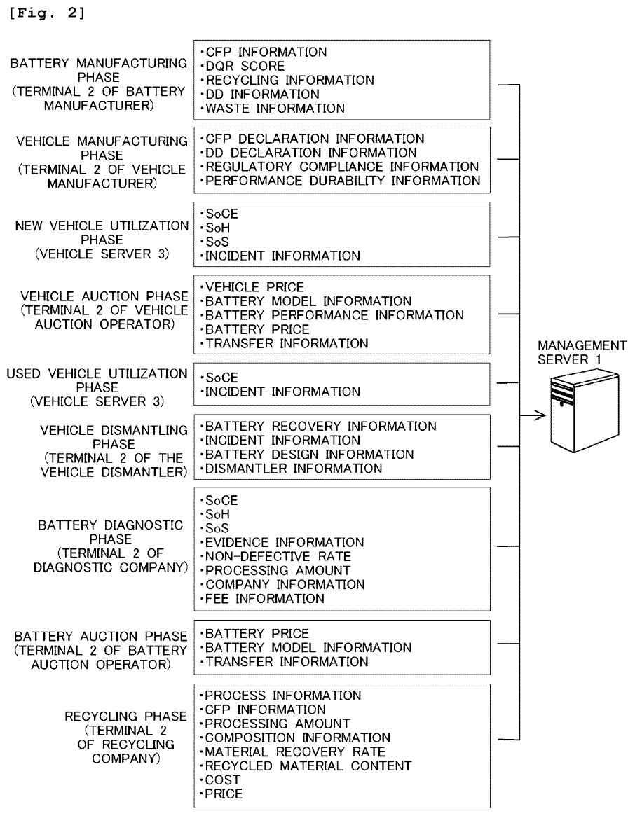

Here, the battery information collected in each phase of the battery life cycle will be described. FIG. 2 is a diagram illustrating an example of battery information provided to the management server 1 from a user involved in each phase of the battery life cycle. In the present embodiment, it is assumed that the items included in the battery information provided from the user involved in each phase to the management server 1 are defined for each phase. Note that the battery information illustrated in FIG. 2 is one example, and may be changed as appropriate in accordance with the embodiment, regulations, or the like.

In the example illustrated in FIG. 2, in the battery manufacturing phase, battery information including information on greenhouse gases (CFP (Carbon Footprint of Products) information), DOR (Data Quality Rating of the dataset) score, recycling information (amount of recycled materials used, and the like), and waste information (amount of wastes, and the like), etc., is provided from the terminal 2 of the battery manufacturer to the management server 1.

In the vehicle manufacturing phase, battery information including CFP declaration information, DD (Due Diligence) declaration information, regulatory compliance information, performance durability information, etc., is provided from the terminal 2 of the vehicle manufacturer to the management server 1.

In the new vehicle utilization phase, battery information including SoCE, SoH, SoS, incident information, etc., is provided from the vehicle server 3 to the management server 1. At least a part of SoCE, SoH, and SoS handled in the new vehicle utilization phase may be presumptively calculated.

In the vehicle auction phase, battery information including the price of the vehicle to be bought or sold, the model information of the battery to be installed in the vehicle, performance information of the battery to be installed in the vehicle, the price of the battery to be installed in the vehicle, the transfer information of the vehicle, etc., is provided from the terminal 2 of the vehicle auction operator to the management server 1.

In the used vehicle utilization phase, battery information including the SoC, the incident information, and the like is provided from the vehicle server 3 to the management server 1.

In the vehicle dismantling phase, battery information including the battery recovery information, the incident information, the battery design information, the information on the vehicle dismantler (the dismantler information), etc., is provided from the terminal 2 of the vehicle dismantler to the management server 1.

In the battery diagnostic phase, battery information including the SoCE of the battery recovered from the vehicle dismantled in the vehicle dismantling phase, the SoH of the battery, the SoS of the battery, the evidence information of diagnosis, the non-defective or yield rate of the model to which the battery belongs, the amount of batteries diagnosed by the battery diagnostic company per predetermined period (processing amount), the information on the battery diagnostic company, the fee information for the diagnosis of the battery, etc., is provided from the terminal 2 of the battery diagnostic company to the management server 1.

In the battery auction phase, battery information including the price of the battery that has been diagnosed in the battery diagnostic phase, the model information of the battery, the transfer information of the battery, etc., is provided from the terminal 2 of the battery auction operator to the management server 1.

In the recycling phase, battery information including information on the recycling process of the battery (process information), the CFP information, the amount of batteries recycled by the recycling company (processing amount), the composition information of the battery, the recovery rate of materials recovered as recycled materials batteries (material recovery rate), the recycled material content of the battery, the cost of the recycling processing, the price of the recycled materials, etc., is provided from the terminal 2 of the recycling company to the management server 1.

In the present embodiment, the battery information provided to the management server 1 from the terminal 2 of the user and the vehicle server 3 involved in each phase is stored and managed in the management server 1 for each phase. A method of managing battery information by the management server 1 will be described later.

### (Hardware Configuration of System)

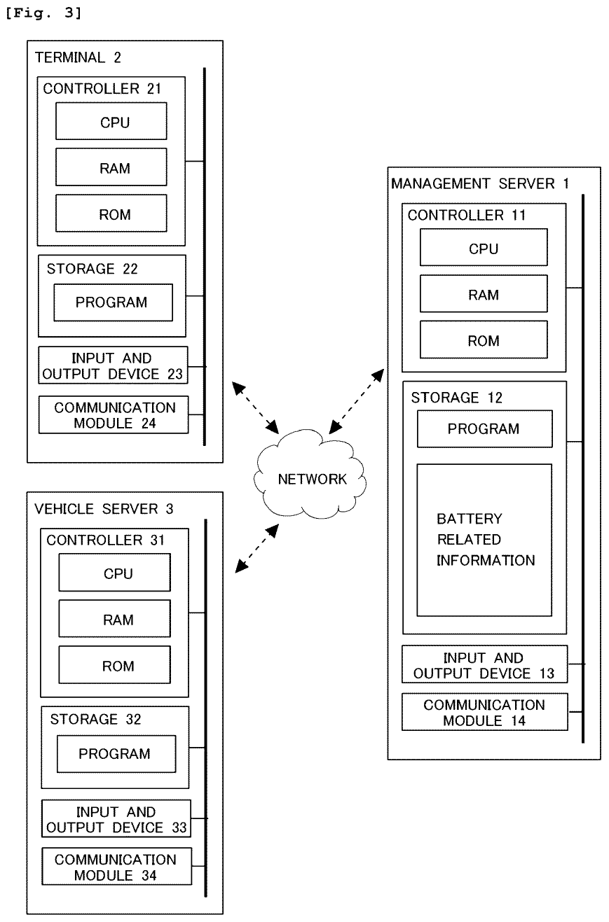

A hardware configuration of each of the management server 1, the terminal 2, and the vehicle server 3 included in the system according to the present embodiment will be described based on FIG. 3. FIG. 3 is a diagram schematically illustrating an example of a hardware configuration of each of the management server 1, the terminal 2, and the vehicle server 3. In the example illustrated in FIG. 3, only one terminal 2 and one vehicle server 3 are illustrated, but two or more terminals 2 corresponding to the phases included in the battery life cycle and two or more vehicle servers 3 corresponding to the number of vehicle manufacturers or vehicle dealers are included in the system.

### [Hardware Configuration of Management Server]

The management server 1 in the present embodiment is one or more computers for centrally managing battery information provided from a plurality of users and a plurality of vehicle servers 3 involved in each phase of a battery life cycle. The management server 1 includes a controller 11, a storage 12, an input and output device 13, and a communication module 14.

The management server 1 can be configured as a computer including a processor (a CPU, a GPU, or the like), a main memory (a RAM, a ROM, or the like), and an auxiliary memory (an EPROM, a hard disk drive, a removable medium, or the like). The auxiliary memory stores a program, data used by the program, and the like, and each function (software module) that matches a predetermined purpose is realized by the processor executing the program stored therein. However, some or all of the functions of the management server 1 may be implemented as a hardware module by a hardware circuit such as an application specific integrated circuit (ASIC), a field programmable gate array (FPGA) or the like.

The controller 11 is an arithmetic logic unit that realizes various functions (software modules) of the management server 1 by executing a program stored in the auxiliary memory. The controller 11 can be realized by a hardware processor such as, for example, a CPU or the like. The controller 11 may be configured to include a RAM, a ROM (Read Only Memory), a cache memory, and the like.

The storage 12 is a means or unit for storing information, and is constituted by a storage medium such as a RAM, a magnetic disk, a flash memory or the like. The storage 12 stores a program to be executed by the controller 11, data to be used by the program, etc. The data used by the program includes battery-related information. The battery-related information includes battery information collected from the plurality of terminals 2 and the vehicle server 3 and information associated with the battery information. Details of the battery-related information will be described later.

The input and output device 13 is a means for accepting input operations performed by an operator of the management server 1 and presenting information to the operator. To be specific, the input and output device 13 includes an input device such as a mouse, a keyboard and the like, and an output device such as a display, a speaker and the like. The input and output device 13 may be integrally configured by, for example, a touch panel display.

The communication module 14 is a communication interface for connecting the management server 1 to the network. The communication module 14 may be configured to include, for example, a network interface board, a wireless communication interface for wireless communication, and the like. The management server 1 can perform data communication with other computers (i.e., the terminal 2, the vehicle server 3, and the like) via the communication module 14.

Note that the specific hardware configuration of the management server 1 can be such that its components are omitted, replaced, or added as appropriate, depending on its implementation. For example, the controller 11 may include a plurality of hardware processors. The hardware processors may each be constituted by a microprocessor, an FPGA, a GPU, or the like. In addition, the input and output device 13 may be omitted, or an input and output device (e.g., an optical drive or the like) other than those exemplified may be added. Also, when the management server 1 is configured to include two or more computers, the hardware configurations of the two or more computers may be the same or different from each other.

### [Hardware Configuration of Terminal]

The terminal 2 according to the present embodiment is a computer used by a user (company) involved in each phase of the battery life cycle, and includes a controller 21, a storage 22, an input and output device 23, and a communication module 24.

Similarly to the management server 1, the terminal 2 according to the present embodiment can be configured as a computer including a processor, a main memory, and an auxiliary memory. The auxiliary memory stores a program, data used by the program, and the like, and each function (software module) that matches a predetermined purpose is realized by the processor executing the program stored therein. Some or all of the functions of the terminal 2 may be implemented as a hardware module by a hardware circuit such as an ASIC, an FPGA, or the like.

The controller 21 is an arithmetic logic unit that realizes various functions (software modules) of the terminal 2 by executing a program stored in the auxiliary memory. The controller 21 can be realized by a hardware processor such as, for example, a CPU or the like. Also, the controller 21 may be configured to include a RAM, a ROM (Read Only Memory), a cache memory, and the like.

The storage 22 is a unit for storing information, and is constituted by a storage medium such as a RAM, a magnetic disk, a flash memory or the like. The storage 22 stores a program to be executed by the controller 21, data to be used by the program, etc. The data used by the program may include, in one example, the information necessary to generate the battery information to be provided from the terminal 2 to the management server 1.

The input and output device 23 is a device for accepting input operations performed by an operator (employee of the company) of the terminal 2 and presenting information to the operator. The specific configuration of the input and output device 23 may be similar to that of the management server 1.

The communication module 24 is a communication interface for connecting the terminal 2 to the network. The specific configuration of the communication module 24 may be similar to that of the management server 1. The terminal 2 can perform data communication with other computers (such as the management server 1 and the like) via the communication module 24.

Note that the specific hardware configuration of the terminal 2 may be such that its components are omitted, replaced, or added as appropriate depending on its implementation.

### [Hardware Configuration of Vehicle Server]

The vehicle server 3 in the present embodiment is one or more computers operated by a vehicle manufacturer, a vehicle dealer, or the like, and includes a controller 31, a storage 32, an input and output device 33, and a communication module 34.

The vehicle server 3, similar to the management server 1, can be configured as a computer including a processor, a main memory, and an auxiliary memory. The auxiliary memory stores a program, data used by the program, and the like, and each function (software module) that matches a predetermined purpose is realized by the processor executing the program stored therein. However, some or all of the functions of the vehicle server 3 may be realized as a hardware module by using a hardware circuit such as an ASIC, an FPGA or the like.

The controller 31 is an arithmetic logic unit that realizes various functions (software modules) of the vehicle server 3 by executing a program stored in the auxiliary memory. The controller 31 can be realized by a hardware processor such as, for example, a CPU or the like. Also, the controller 21 may be configured to include a RAM, a ROM (Read Only Memory), a cache memory, and the like.

The storage 32 is a means or unit for storing information, and is constituted by a storage medium such as a RAM, a magnetic disk, a flash memory or the like. The storage 32 stores a program to be executed by the controller 31, data to be used by the program, etc. The data used by the program may include, in one example, the information necessary to generate the battery information to be provided from the vehicle server 3 to the management server 1.

The input and output device 33 is a means for accepting input operations performed by an operator of the vehicle server 3 and presenting information to the operator. The specific configuration of the input and output device 33 may be similar to that of the management server 1.

The communication module 34 is a communication interface for connecting the vehicle server 3 to the network. The specific configuration of the communication module 34 may be similar to that of the management server 1. The vehicle server 3 can perform data communication with other computers (such as the management server 1 and the like) via the communication module 34.

Note that the specific hardware configuration of the vehicle server 3 can be such that its components are omitted, replaced, or added as appropriate, depending on its implementation.

### (Software Configuration of System)

A functional configuration (software configuration) of each of the management server 1, the terminal 2, and the vehicle server 3 included in the system according to the present embodiment will be described.

### [Software Configuration of Management Server]

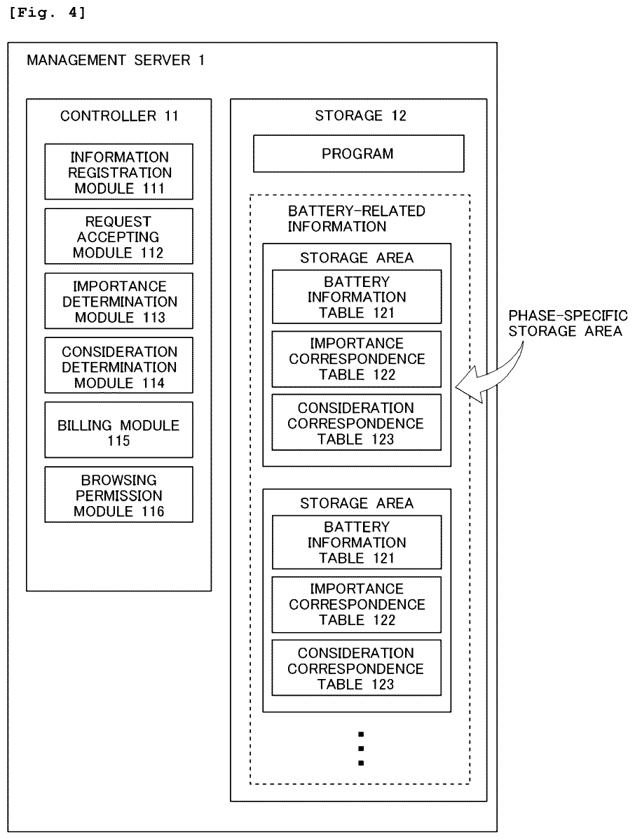

FIG. 4 is a block diagram illustrating an example of a software configuration of the management server 1 in the present embodiment. The controller 11 of the management server 1 in the present embodiment has a plurality of software modules including an information registration module 111, a request accepting module 112, an importance determination module 113, a consideration determination module 114, a billing module 115, and a browsing permission module 116. These software modules are realized by the controller 11 executing a program stored in the storage 12. At least a part of the information registration module 111, the request accepting module 112, the importance determination 113, module the consideration determination module 114, the billing module 115, and the browsing permission module 116 may be realized by a hardware circuit. In the following description, information processing executed by each of the information registration module 111, the request accepting module 112, the importance determination module 113, the consideration determination module 114, the billing module 115, and the browsing permission module 116 is synonymous with information processing executed by the controller 11.

The information registration module 111 receives the battery information transmitted from the terminal 2 and the vehicle server 3 through the communication module 14. The information registration module 111 registers (stores) the received battery information in the storage 12. The storage 12 in the present embodiment includes a plurality of storage areas respectively corresponding to a plurality of phases included in the battery life cycle. In each storage area, a battery information table 121 is stored.

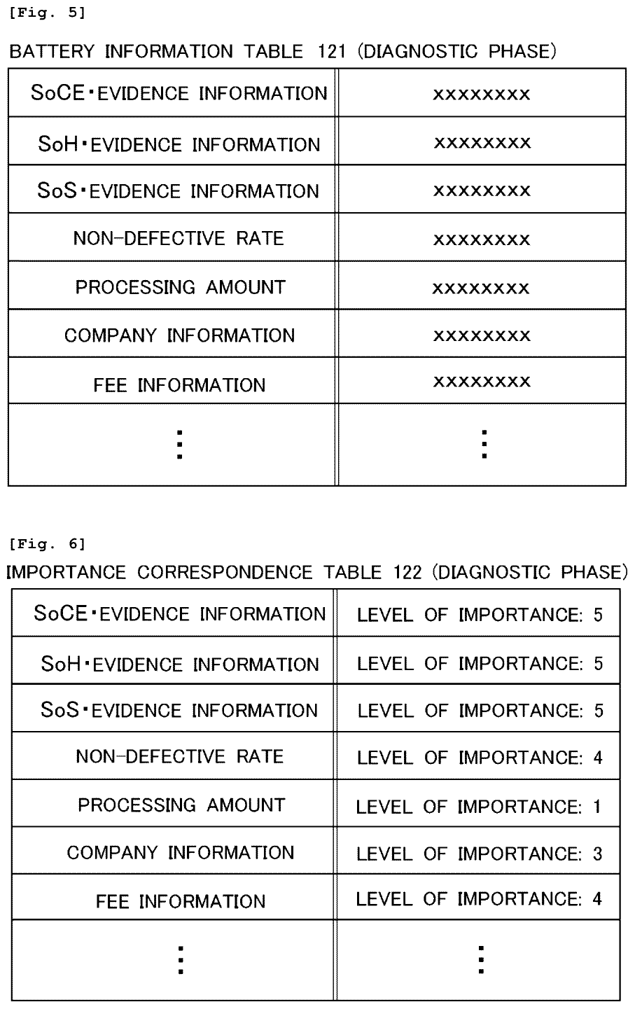

FIG. 5 is a diagram schematically illustrating an example of the battery information table 121 in the present embodiment. The battery information table 121 illustrated in FIG. 5 is a table in which battery information corresponding to the diagnostic phase (battery information provided from the terminal 2 of the diagnostic company) is registered. The battery information table 121 has a plurality of records for each item defined for each phase. In the example illustrated in FIG. 5, the battery information table 121 has a plurality of records including SoCE evidence information, SoH evidence information, SoS evidence information, non-defective rate, processing amount, company information, fee information, and the like. The records (items) included in the battery information table 121 may differ for each phase included in the battery life cycle. For example, as illustrated in FIG. 2, in cases where the battery information collected in the vehicle manufacturing phase includes the CFP declaration information, the DD declaration information, the regulatory compliance information, the performance durability information, etc., records (items) corresponding to the CFP declaration information, the DD declaration information, the regulatory compliance information, the performance durability information, etc., are set in the battery information table 121 in the storage area corresponding to the vehicle manufacturing phase.

Returning to the description of FIG. 4, the information registration module 111 registers the received battery information in the battery information table 121 in the storage area corresponding to the phase of the battery information, for each item. Note that the battery information transmitted from the terminal 2 and the vehicle server 3 to the management server 1 may include an identifier (e.g., phase ID) for identifying the phase to which the battery information belongs. In this case, the information registration module 111 may identify the storage area corresponding to the phase to which the battery information belongs, by using the phase ID included in the battery information as an argument, and register the battery information in the battery information table 121 in the storage area thus identified.

The request accepting module 112 accepts a browsing request from a user (hereinafter, also referred to as a “first user”) involved in any of the plurality of phases included in the battery life cycle. In the system of the present embodiment, as described above, the first user can browse the battery information of the previous phase in addition to at least the battery information of the phase in which the user is involved (the battery information provided to the management server by the user). However, when the first user browses the battery information of the previous phase, a browsing restriction is set for at least one item of the battery information. When the first user wants to browse an item for which a browsing restriction is set, the first user transmits a browsing request for the item to be browsed (target item) to the management server 1 through the terminal 2. Such a browsing request may include an identifier of the first user (user ID (e.g., an account of a business to which the user belongs)) and an identifier of the target item (item ID). Note that the acceptance of the browsing request by the request accepting module 112 may be made through the execution of a web server or through an application program installed in the terminal 2. In response to the request accepting module 112 accepting the browsing request, the controller 11 of the management server 1 operates as the importance determination module 113.

The importance determination module 113 determines the level of importance set to the target item of the browsing request. The level of importance in the present embodiment is determined using, as an index, the degree of influence on the business of a user (a user involved in the previous phase (hereinafter, also referred to as a “second user”)) who is the source of the information of the target item and/or the accuracy of the information of the target item. In one example, the level of importance may be set to be higher for an item in which information with a high possibility that the know-how of the second user is grasped by the first user is registered (an item in which information with a large degree of influence on the business of the second user is registered) like the evidence information such as SoCE, SoH, SoS and the like. In another example, the level of importance may be set to be higher for items for which information, such as fee information, is registered that is likely to allow the first user to understand the form of transactions of the second user (i.e., items for information that has a greater impact on the business of the second user). Further, in another example, for an item in which information of accuracy such as a diagnosis value is registered rather than an estimated value, the level of importance may be set to be higher than that of an item in which an estimated value is registered. Furthermore, in another example, for an item for which information that has been certified for accuracy by a third party such as a vehicle manufacturer is registered, the importance may be set to be higher than for an item for which information that has not been certified for accuracy by a third party is registered.

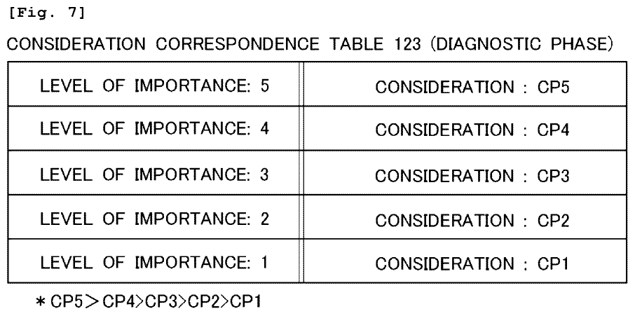

In the present embodiment, the level of importance as described above is set for each phase and for each item. Accordingly, in addition to the battery information table 121 described above, an importance correspondence table 122 is stored in each storage area of the storage 12 in the present embodiment. FIG. 6 is a diagram schematically illustrating an example of an importance correspondence table in the present embodiment. The importance correspondence table 122 illustrated in FIG. 6 corresponds to the battery information in table 121 the diagnostic phase. The importance correspondence table 122 is a table (corresponding to “first information” according to the present disclosure) that associates each of the items defined for each phase (in the example of FIG. 6, the items set in the battery information table 121 for the diagnostic phase) with a level of importance. In the importance correspondence table 122 illustrated in FIG. 6, a level of importance is registered which corresponds to each of a plurality of items including the SoCE evidence information, the SoH evidence information, the SoS evidence information, the non-defective rate, the processing amount, the company information, the fee information, and the like.

Here, the description returns to FIG. 4. When determining the level of importance of a target item, the importance determination module 113 first identifies the phase (previous phase) of the battery information that the first user wants to browse, according to the user ID included in the browsing request. The importance determination module 113 accesses the importance correspondence table 122 stored in the storage area corresponding to the previous phase thus identified. The importance determination module 113 determines the level of importance of the target item by referring to the importance correspondence table 122 using the item ID included in the browsing request as an argument. In response to the determination of the importance level of the target item by the importance determination module 113, the controller 11 of the management server 1 operates as the consideration determination module 114.

The consideration determination module 114 determines a consideration corresponding to the level of importance determined by the importance determination module 113. The consideration in the present embodiment is set to be larger as the level of importance is higher. The amount (absolute value) of the consideration corresponding to the level of importance may be common to a plurality of phases included in the battery life cycle, or may be different for each phase. In the present embodiment, an example will be described in which the amount of the consideration corresponding to the level of importance is different for each phase included in the battery life cycle. In this case, in addition to the battery information table 121 and the importance correspondence table 122 described above, a consideration correspondence table 123 is stored in each storage area of the storage 12 in the present embodiment.

FIG. 7 is a diagram schematically illustrating an example of the consideration correspondence table in the present embodiment. The consideration correspondence table 123 illustrated in FIG. 7 corresponds to the battery information table 121 in the diagnostic phase. The consideration correspondence table 123 is a table (corresponding to the “second information” in this disclosure) that associates the importance in the phase with the consideration. In the consideration correspondence table 123 illustrated in FIG. 7, five levels of importance from importance level “1” to importance level “5” are set, with the larger the number, the higher the importance level. Accordingly, the larger the number of the level of importance is, the larger the consideration is set.

Here, the description returns to FIG. 4. When determining the consideration corresponding to the level of importance of a target item, the consideration determination module 114 first identifies the phase (previous phase) of the battery information that the first user wants to browse according to the user ID included in the browsing request. The consideration determination module 114 accesses the consideration correspondence table 123 stored in the storage area corresponding to the previous phase thus identified. The consideration determination module 114 determines the consideration corresponding to the level of importance of the target item by referring to the consideration correspondence table 123 using the level of importance determined by the importance determination module 113 as an argument. In response to the consideration determination module 114 determining the consideration corresponding to the level of importance of the target item, the controller 11 of the management server 1 operates as the billing module 115.

The billing module 115 executes a process of prompting the first user to pay the consideration determined by the consideration determining unit 114. In one example, the billing module 115 may display a screen on the input and output device 23 of the terminal 2 that prompts the user to select whether or not to agree to pay the consideration, either through the execution of the web server or through an application program of the terminal 2. In such a case, in response to the first user inputting an operation for agreeing to pay the consideration to the input and output device 23 of the terminal 2, information indicating that the first user has agreed to pay the consideration may be transmitted from the terminal 2 to the management server 1. Then, in response to the receipt of such information by the management server 1, the billing module 115 may perform a billing process for an amount of money corresponding to the consideration. Note that, in response to the completion of the billing process, the billing module 115 may transmit information on the first user and the target item to the terminal 2 of the second user who is the provider of the battery information including the target item. In addition, the billing module 115 may inquire of the second user whether to permit the first user to browse the target item before executing the billing process. Then, only when the second user permits the first user to browse the target item, the billing module 115 may execute the billing process. When the billing module 115 finishes executing the billing process in this manner, the controller 11 of the management server 1 operates as the browsing permission module 116.

The browsing permission module 116 permits the first user to browse the target item. In one example, the browsing permission module 116 may display on the input and output device 23 of the terminal 2 a screen on which only information on items for which browsing restrictions have not been set (or for which payment has already been made) among battery information including the target item, and may display the information of the target item in response to the execution of the billing process for the target item. In another example, the browsing permission module 116 may transmit the information of the target item to the terminal 2 through the communication module 14. Note that, when permitting the browsing of the target item, the browsing permission module 116 may transmit to the terminal 2 a command to display information guaranteeing the reliability of the information of the target item. In one example, the information guaranteeing the reliability of the information of the target item may be a signature or the like of a business operator (e.g., a battery manufacturer, a vehicle manufacturer, or the like) a third-party organization, guaranteeing the reliability of the information. Such information may be stored in the battery information table 121 in association with each item of the battery information.

Here, note that the software configuration of the management server 1 is not limited to the example illustrated in FIG. 4, and software modules can be omitted, replaced, or added as appropriate depending on its implementation.

### [Software Configuration of Terminal]

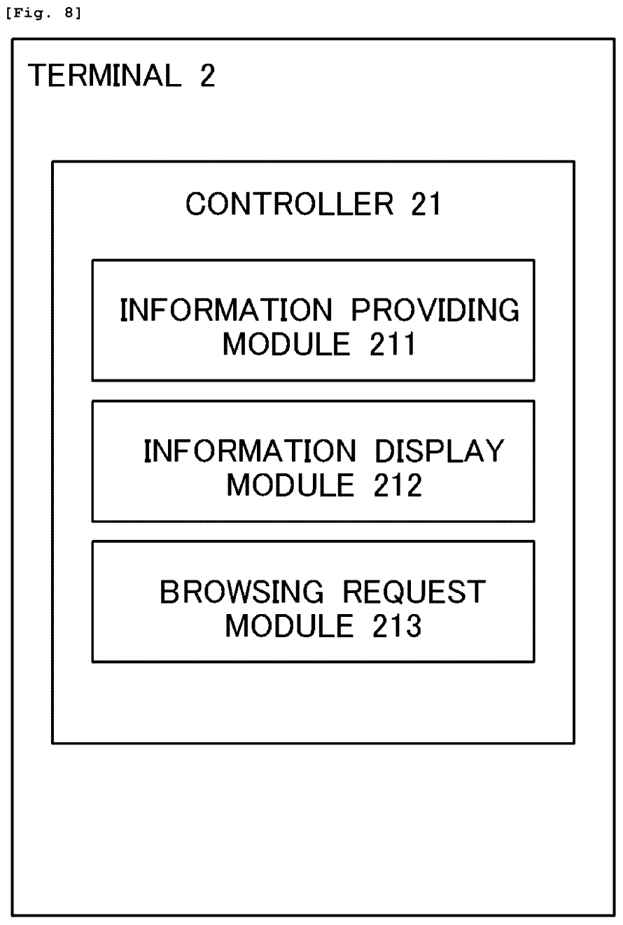

FIG. 8 is a block diagram illustrating an example of a software configuration of the terminal 2 in the present embodiment. The controller 21 of the terminal 2 according to the present embodiment is configured to include a plurality of software modules including an information providing module 211, an information display module 212, and a browsing request module 213. These software modules are realized by the controller 21 executing a program stored in the storage 22. At least a part of the information providing module 211, the information display module 212, and the browsing request module 213 may be implemented by a hardware circuit. In addition, in the following description, information processing executed by each of the information providing module 211, the information display module 212, and the browsing request module 213 is synonymous with information processing executed by the controller 21.

The information providing module 211 transmits (provides) the battery information of the phase in which the user of the terminal 2 is involved to the management server 1 via the communication module 24.

The information display module 212 displays, on the input and output device 23, the battery information corresponding to the previous phase of the phase in which the user of the terminal 2 is involved. For example, when the user logs into the management server 1 with a vendor's account and inputs an operation for displaying the battery information of the previous phase to the input and output device 23, the information display module 212 displays the battery information of the previous phase on the input and output device 23. At this time, the information display module 212 may interact with the management server 1 through the execution of a web browser of the terminal 2 or through the execution of a dedicated application program installed in the terminal 2.

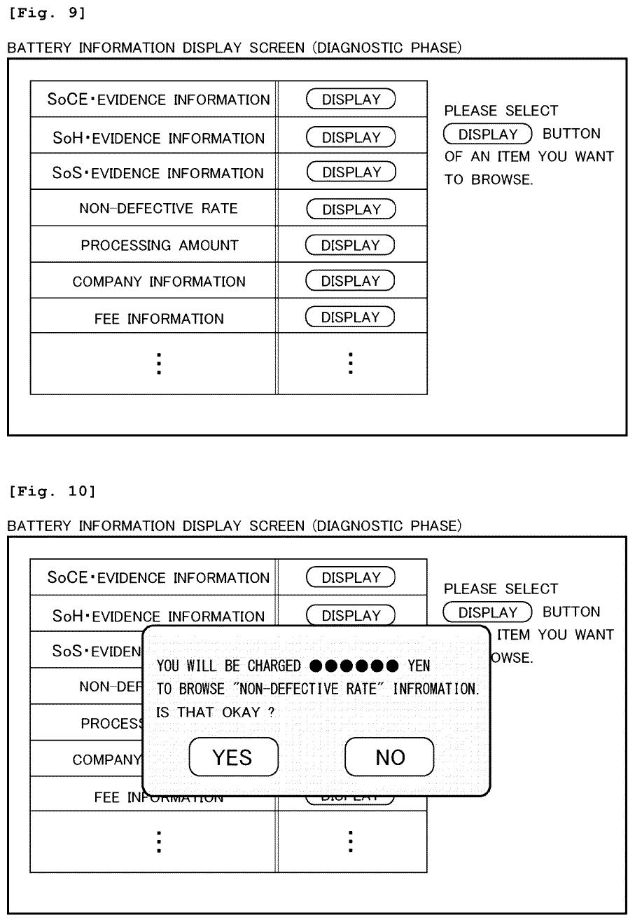

Here, an example of the screen (battery information display screen) displayed on the input and output device 23 by the information display module 212 is illustrated in FIG. 9. The battery information display screen of FIG. 9 is an example of a screen in a case where the previous phase is the diagnostic phase. In the example illustrated in FIG. 9, browsing restrictions are set for all the items included in the battery information in the diagnostic phase. Then, in an information display column of an item for which a browsing restriction is set, a graphical user interface (GUI) component indicating a “display” button is displayed instead of the information of the item. The “display” button is used for making a browsing request for the corresponding item. In response to this, the battery information display screen displays, in addition to the battery information, a message prompting the user to operate the “display” button of the item that the user wants to browse. When the “display” button of an item (target item) that the user wants to browse on the battery information display screen is operated (clicked or tapped), the controller 21 of the terminal 2 operates as the browsing request module 213.

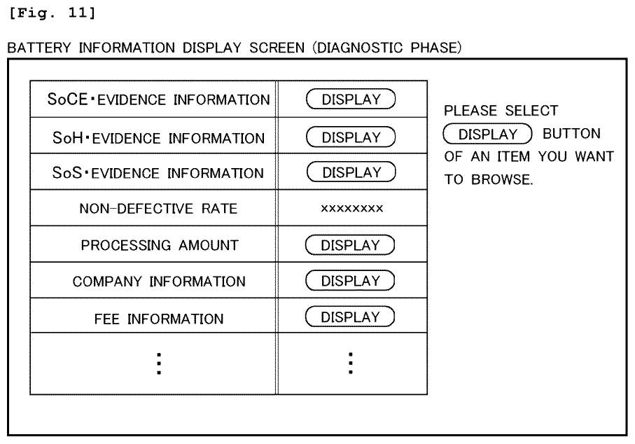

In response to the “display” button of the target item being operated, the browsing request module 213 transmits to the management server 1 a browsing request including the user ID of the user (corresponding to the first user) and the item ID of the target item. The browsing request may be transmitted to the management server 1 through the web browser of the terminal 2, or through the execution of the dedicated application program installed in the terminal 2. In response to this, when a command to display a screen prompting the user to select whether or not to agree to the payment of consideration is transmitted from the management server 1 to the terminal 2, the browsing request module 213 displays a GUI component on the input and output device 23 to prompt the user to select whether or not to agree to the payment of consideration. FIG. 10 is a diagram illustrating an example of a screen on which a GUI component is displayed for prompting the user to select whether or not to agree to pay the consideration. In the example illustrated in FIG. 10, the GUI component for prompting the user to select whether or not to agree to pay the consideration is displayed as a pop-up window on the battery information display screen. The pop-up window includes a price for browsing the target item (the item of the non-defective rate in the example illustrated in FIG. 10), a “YES” button for selecting to agree to pay the consideration (price), and a “NO” button for selecting not to agree to pay the consideration. When the “YES” button is operated on the screen of FIG. 10, the browsing request module 213 transmits to the management server 1 indicating that the user agrees to pay the consideration. In response to this, when a signal permitting browsing of the target item is transmitted from the management server 1 to the terminal 2, the controller 21 of the terminal 2 operates as the information display module 212.

The information display module 212 displays the information of the target item on the battery information display screen in response to receiving the signal permitting browsing of the target item. FIG. 11 is a diagram illustrating an example of the battery information display screen in a state in which the information of the target item is displayed. In the example illustrated in FIG. 11, information indicating the non-defective rate is displayed in the information display column for the item of the non-defective rate, instead of the “display” button. Note that information for guaranteeing the reliability of the non-defective rate (e.g., a signature of a battery manufacturer, a vehicle manufacturer, a third-party organization, or the like) may be displayed on the screen on which the information of the target item is displayed. Such information may be transmitted from the management server 1 to the terminal 2 in the form of being included in a signal permitting browsing of the target item.

Here, note that the software configuration of the terminal 2 is not limited to the example illustrated in FIG. 8, and software modules can be omitted, replaced, or added as appropriate depending on its implementation.

### [Software Configuration of Vehicle Server]

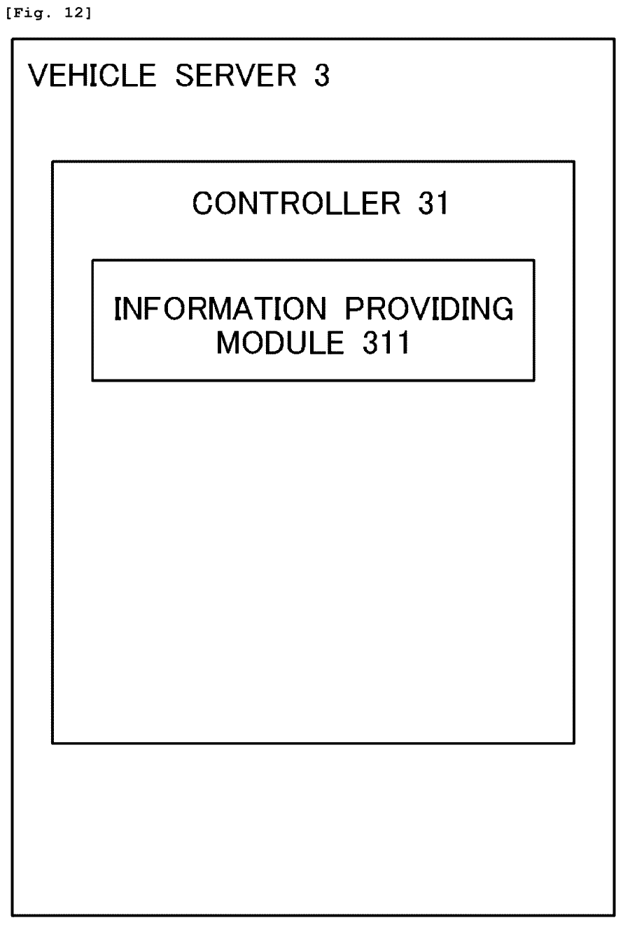

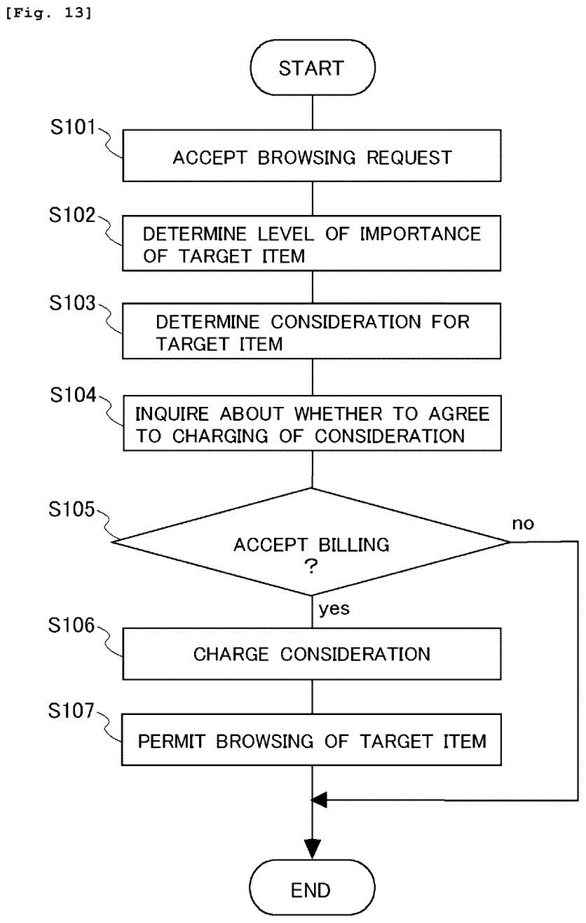

FIG. 12 is a block diagram illustrating an example of a software configuration of the vehicle server in the present embodiment. The controller 31 of the vehicle server according to the present embodiment is configured to include a software module including an information providing module 311. Such a software module is realized by the controller 31 executing a program stored in the storage 32. Note that the information providing module 311 may be implemented by a hardware circuit. In addition, in the following description, information processing executed by the information providing module 311 is synonymous with information processing executed by the controller 31.

The information providing module 311 collects various types of information on the battery mounted on the vehicle from the vehicle under the management of the vehicle server 3. The information thus collected from the vehicle by the information providing module 211 is information necessary for generating battery information corresponding to the new vehicle utilization phase and the used vehicle utilization phase. In one example, the information collected from the vehicle by the information providing module 311 may be information necessary for estimating SoH, SoC, SoCE, SOS, and the like. The information providing module 211 generates battery information corresponding to the new vehicle utilization phase and the used vehicle utilization phase according to the information collected from the vehicle, and provides the battery information thus generated to the management server 1.

Here, note that the software configuration of the vehicle server 3 is not limited to the example illustrated in FIG. 12, and software modules can be replaced or added as appropriate depending on its implementation.

### (Flow of Processing)

The flow of processing to be executed by the management server 1 in the present embodiment will be described based on FIG. 13. FIG. 13 is a flowchart illustrating an example of a processing routine to be executed by the management server 1 upon accepting a browsing request from the terminal 2 of the first user as a trigger. Although the processor (controller 11) of the management server 1 is the main executor of the processing routine in FIG. 13, the software module of the management server 1 will be described here as the main executor.

In the processing routine of FIG. 13, when the communication module 14 receives a browsing request transmitted from the terminal 2, the controller 11 of the management server 1 operates as the request accepting module 112 to accept the browsing request received by the communication module 14 (step S101). When the request accepting module 112 finishes executing the process in step S101, the controller 11 of the management server 1 operates as the importance determination module 113 to execute the process in step S102.

In step S102, the importance determination module 113 determines the level of importance set to the item (target item) that is the target of the browsing request. For example, the importance determination module 113 first identifies the phase (previous phase) of the battery information that the first user wants to browse according to the user ID included in the browse request. The importance determination module 113 accesses the importance correspondence table 122 stored in the storage area corresponding to the phase identified. The importance determination module 113 determines the level of importance of the target item by referring to the importance correspondence table 122 using the item ID included in the browsing request as an argument. When the importance determination module 113 finishes executing the process of step S102, the controller 11 of the management server 1 operates as the consideration determination module 114 to execute the process of step S103.

In step S103, the consideration determination module 114 determines the consideration corresponding to the level of importance determined in step S102. To be specific, the consideration determination module 114 first identifies the phase (previous phase) of the battery information that the first user wants to browse according to the user ID included in the browsing request. The consideration determination module 114 accesses the consideration correspondence table 123 stored in the storage area corresponding to the phase thus identified. The consideration determination module 114 determines the consideration corresponding to the level of importance of the target item by referring to the consideration correspondence table 123 using the level of importance determined by the importance determination module 113 as an argument. When the consideration determination module 114 ends the process of step S103, the controller 11 of the management server 1 operates as the billing module 115 to execute the process of step S104.

In step S104, the billing module 115 inquires of the first user whether or not to agree to pay the consideration determined by the consideration determination module 114. In one example, as illustrated in FIG. 10 described above, the billing module 115 may transmit, to the terminal 2, a display command for causing the input and output device 23 of the terminal 2 of the first user to display a pop-up window for prompting the first user to select whether or not to agree to the payment of the consideration. In response to this, when a signal indicating the result of the selection of whether or not to agree to the payment of the consideration is transmitted from the terminal 2 of the first user to the management server 1, the billing module 115 executes the process of step S105.

In step S105, the billing module 115 determines whether or not the selection result of the first user is to agree to the payment of the consideration. If the selection result of the first user indicates that the user does not agree to pay the consideration (negative determination in step S105), the execution of the processing routine of FIG. 13 is ended. On the other hand, if the selection result of the first user is to agree to pay the consideration (positive determination in step S105), the billing module 115 executes the process of step S106.

In step S106, the billing module 115 performs a billing process for the first user for an amount of money corresponding to the consideration. The billing module 115 may transmit information on the first user and the target item to the terminal 2 of the second user in response to the completion of the billing processing. When the billing module 115 finishes executing the process of step S106, the controller 11 of the management server 1 operates as the browsing permission module 116 to execute the process of step S107.

In step S107, the browsing permission module 116 permits the first user to browse the target item. In one example, as illustrated in FIGS. 9 and 10 described above, the browsing permission module 116 may switch the battery information display screen displayed on the input and output device 23 of the terminal 2 of the first user from a screen in which the information of the target item is not displayed (e.g., the screen illustrated in FIG. 9) to a screen in which the information of the target item is displayed (e.g., the screen illustrated in FIG. 11). In another example, the browsing permission module 116 may transmit the information of the target item to the terminal 2 of the first user through the communication module 14. When the browsing permission module 116 finishes executing the process of step S107, the controller 11 of the management server 1 finishes the execution of the processing routine of FIG. 13.

### Operation and Effects of Embodiment

In the embodiment described above, in a system that centrally manages information collected in a plurality of phases included in a battery life cycle, when information with a high level of importance for a second user who is an information provider is made available to a first user who wants to browse the information, a consideration to be paid to the second user can be charged to the first user. The level of importance at that time is set to be higher as the degree of influence of the information to be browsed on the business of the second user is higher and/or as the accuracy of the information to be browsed is higher. Further, as the level of importance of the information to be browsed increases, the consideration (price) to be paid from the first user to the second user can be increased.

Therefore, according to the above-described embodiment, the first user can browse information of the level of importance commensurate with the consideration (price) by paying the consideration according to the level of importance. On the other hand, the second user can obtain the consideration corresponding to the level of importance of the information to be browsed by the first user. As a result, the interests of the first and second users can be harmonized. Thus, it is possible to appropriately provide and browse information on the battery.

### <Others>

The above-described embodiment is merely an example, and the present disclosure can be appropriately modified and implemented within a range not departing from the gist thereof. For example, the processes described as being performed by one device or unit may be shared and performed by a plurality of devices or units. Alternatively, the processes described as being performed by different devices or units may be performed by a single device or unit. In a computer system, it is possible to flexibly change the hardware configuration that can achieve each function of the computer system.

In addition, the above-mentioned embodiment, a battery for driving a vehicle is taken as an example of a target object according to the present disclosure, but the target object may be any product that is distributed through a plurality of phases from manufacturing to recycling.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. A communication system comprising:
a plurality of terminals; and
a server connected to the plurality of the terminals,
wherein the server comprising:
a storage configured to store a first data table which registers one or more pieces of information on a target object for each of its entries; and
a controller configured to execute a web server that interacts with the plurality of terminals;
wherein the web server is configured to execute:
receiving, from a first terminal which is one of the plurality of terminals, a request signal to access a target entry, which is one of the plurality of entries in the first table;
determining a level of importance set for the target entry among levels of importance respectively set for the plurality of entries;
determining a consideration corresponding to the level of importance of the target entry;
transmitting a request signal for settlement of the consideration to the first terminal; and
transmitting a command signal for displaying information of the target entry on a display device of the first terminal to the first terminal, in response to receiving settlement completion signal from the first terminal.

2. An information processing apparatus comprising:
a storage configured to store one or more pieces of information on a target object for each of its items; and
a controller;
wherein the controller is configured to execute:
accepting, from a first user, a request to browse a target item, which is one of the plurality of items in the storage;
requesting a predetermined procedure to the first user; and
permitting the first user to browse the target item in response to execution of the predetermined procedure; and
wherein the predetermined procedure may be determined according to a level of importance set for the target item.

3. The information processing apparatus according to claim 2, wherein
the predetermined procedure includes provision of a consideration to a second user who is an information provider of the target item; and
the consideration is set to be higher as the level of importance of the target item is higher.

4. The information processing apparatus according to claim 3, wherein the level of importance is set to be higher as a degree of influence of information of the target item on a business of the second user is larger.

5. The information processing apparatus according to claim 3, wherein the level of importance is set to be higher as accuracy of information of the target item is higher.

6. The information processing apparatus according to claim 5, wherein permitting the first user to browse the target item further includes providing the first user with information that guarantees reliability of the information of the target item.

7. The information processing apparatus according to claim 2, wherein
the storage is configured to further store first information that associates each of the plurality of items with the level of importance; and
the controller identifies the level of importance of the target item according to the first information.

8. The information processing apparatus according to claim 2, wherein
the storage is configured to further store second information that associates the level of importance with the predetermined procedure; and
the controller determines the predetermined procedure corresponding to the level of importance of the target item according to the second information.

9. The information processing apparatus according to claim 2, wherein the target object is a battery for driving a vehicle.

10. An information processing method for causing a computer, which includes a storage configured to store one or more pieces of information on a target object for each of its items, to execute:
accepting, from a first user, a request to browse a target item, which is one of the plurality of items in the storage;
requesting a predetermined procedure to the first user; and
permitting the first user to browse the target item in response to execution of the predetermined procedure; and
wherein the predetermined procedure may be determined according to a level of importance set for the target item.

11. The information processing method according to claim 10, wherein
the predetermined procedure includes provision of a consideration to a second user who is an information provider of the target item; and
the consideration is set to be higher as the level of importance of the target item is higher.

12. The information processing method according to claim 11, wherein the level of importance is set to be higher as a degree of influence of information of the target item on a business of the second user is larger.

13. The information processing method according to claim 11, wherein the level of importance is set to be higher as accuracy of information of the target item is higher.

14. The information processing method according to claim 13, wherein permitting the first user to browse the target item further includes providing the first user with information that guarantees reliability of the information of the target item.

15. The information processing method according to claim 10, wherein
the storage is configured to further store first information that associates each of the plurality of items with the level of importance; and
the computer identifies the level of importance of the target item according to the first information.

16. The information processing method according to claim 10, wherein
the storage is configured to further store second information that associates the level of importance with the predetermined procedure; and
the computer determines the predetermined procedure corresponding to the level of importance of the target item according to the second information.

17. The information processing method according to claim 10, wherein the target object is a battery for driving a vehicle.
